(19) United States
(12) Patent Application Publication
(10) Pub. No.: US 2026/0310941 A1
(43) Pub. Date: Oct. 8, 2026

(54) EFFICIENT AUTOREGRESSIVE INFERENCE OF LARGE LANGUAGE MODELS (LLMS) WITH STATIC COMPILATION

(71) Applicant: QUALCOMM Incorporated, San Diego, CA (US)

(72) Inventors: Colin Beaton VERRILLI, Apex, NC (US); Natarajan VAIDHYANATHAN, Chapel Hill, NC (US); Geoffrey Carlton BERRY, Durham, NC (US); Rishi CHATURVEDI, San Diego, CA (US); Karamvir CHATHA, San Diego, CA (US); Srinivasan RAMANI, Cary, NC (US); Anuj GUPTA, Bangalore (IN); Venkata Subba Dheeraj GATTUPALLI, Nellore (IN)

(21) Appl. No.: 19/480,340

(22) PCT Filed: Dec. 6, 2023
(86) PCT No.: PCT/US2023/082778

§ 371 Date: Oct. 30, 2025

(30) Foreign Application Priority Data
Jul. 8, 2023 (IN) 202341045999

(51) Int. Cl. G06N 3/047

(52) U.S. Cl. CPC G06N 3/047

(57) ABSTRACT

A processor-implemented method for adapting autoregressive inference of large language models (LLMs) for static compilation includes defining a maximally sized static data structure and a variable data mask. The variable data mask indicates a valid section of the maximally sized data structure. A set of valid data is determined by applying the variable data mask to the maximally sized static data structure. A computation is performed using only the set of valid data.

### CROSS-REFERENCE TO RELATED APPLICATION

The present application claims the benefit of India patent application No. 202341045999, filed on Jul. 8, 2023, and titled “EFFICIENT AUTOREGRESSIVE INFERENCE OF LARGE LANGUAGE MODELS (LLMs) WITH STATIC COMPILATION,” the disclosure of which is expressly incorporated by reference in its entirety.

### FIELD OF THE DISCLOSURE

Aspects of the present disclosure generally relate to artificial neural networks, and more specifically to efficient autoregressive inference of large language models (LLMs) with static compilation.

### BACKGROUND

Artificial neural networks may comprise interconnected groups of artificial neurons (e.g., neuron models). The artificial neural network may be a computational device or be represented as a method to be performed by a computational device. Convolutional neural networks (CNNs) are a type of feed-forward artificial neural network. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Large language models (LLMs) have grown in popularity due to their usefulness on a wide variety of natural language processing tasks. LLMs may receive a prompt from a user, and in turn may generate a response or completion. However, LLMs may be inefficient in generating the completions.

One approach to address the inefficiency is the use of a compiler. Static compilation of neural networks may generate efficient executables. This is in part because compilers work with fixed-sized tensors and static computational graphs. However, autoregressive inference on LLMs produces tensors that may vary in size. The compilation of LLMs is challenging.

### SUMMARY

The present disclosure is set forth in the independent claims, respectively. Some aspects of the disclosure are described in the dependent claims.

In some aspects of the present disclosure, a processor-implemented method performed by one or more processors includes defining a maximally sized static data structure and a variable data mask. The variable data mask indicates a valid section of the maximally sized static data structure. The processor-implemented method also includes determining a set of valid data by applying the variable data mask to the maximally sized static data structure. The processor-implemented method also includes performing a computation using only the set of valid data.

Various aspects of the present disclosure are directed to an apparatus including means for defining a maximally sized static data structure and a variable data mask. The variable data mask indicates a valid section of the maximally sized static data structure. The apparatus also includes means for determining a set of valid data by applying the variable data mask to the maximally sized static data structure. The apparatus further includes means for performing a computation using only the set of valid data.

In some aspects of the present disclosure, a non-transitory computer-readable medium with program code recorded thereon is disclosed. The program code is executed by a processor and includes program code to define a maximally sized static data structure and a variable data mask. The variable data mask indicates a valid section of the maximally sized static data structure. The program code also includes program code to determine a set of valid data by applying the variable data mask to the maximally sized static data structure. The program code further includes program code to perform a computation using only the set of valid data.

Various aspects of the present disclosure are directed to an apparatus having at least one memory and one or more processors coupled to the at least one memory. The processor(s) is configured to define a maximally sized static data structure and a variable data mask. The variable data mask indicates a valid section of the maximally sized static data structure. The processor(s) is also configured to determine a set of valid data by applying the variable data mask to the maximally sized static data structure. The processor(s) is further configured to perform a computation using only the set of valid data.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network, in accordance with various aspects of the present disclosure.

FIG. 2D is a diagram illustrating an exemplary deep convolutional network (DCN), in accordance with various aspects of the present disclosure.

FIG. 3 is a block diagram illustrating an exemplary deep convolutional network (DCN), in accordance with various aspects of the present disclosure.

FIG. 4 is a block diagram illustrating an exemplary software architecture that may modularize artificial intelligence (AI) functions, in accordance with various aspects of the present disclosure.

FIG. 5 is a block diagram illustrating an example of autoregressive token generation using a language model in accordance with various aspects of the present disclosure.

FIG. 6 is a block diagram illustrating an example architecture of an autoregressive language model (ARLM) configured for static compilation, in accordance with various aspects of the present disclosure.

FIG. 7 is a flow diagram illustrating a processor-implemented method for adapting autoregressive inference of large language models (LLMs) for static compilation, in accordance with various aspects of the present disclosure.

### DETAILED DESCRIPTION

The detailed description set forth below in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Static compilation of neural networks (NNs) typically generates efficient executables because they work with fixed-sized tensors and static computational graphs. That is, the amount and type of computation is not input-dependent. By exploiting the static nature of the computational structure (e.g., tensors and computational graphs), the compiler may pre-allocate and pre-schedule tasks related to the computations for efficient inference.

Autoregressive inference on large language models (LLMs), however, do not have such a static computational structure. The function of LLMs is to produce completions (e.g., responses) for prompts. The prompt and completion may have a variable length, for example. The completion may be produced one token at a time by executing the same computational graph a variable number of times with variable-sized data structures. A key variable-sized data structure is called KV Cache (KV$), which may grow in size during each iteration of token generation. Thus, it is challenging to use static compilation techniques for autoregressive inference of LLMs.

Accordingly, to address these and other challenges, aspects of the present disclosure are directed to adapting autoregressive inference of large language models (LLMs) for static compilation. In accordance with aspects of the present disclosure, a maximal sized data structure may be defined and accompanied by another structure called a mask. The mask may indicate the currently valid section of the maximally size data structure.

Particular aspects of the subject matter described in this disclosure can be implemented to realize one or more of the following potential advantages. In some examples, the described techniques, may improve processing efficiency and reduce latency of autoregressive inference of LLMs.

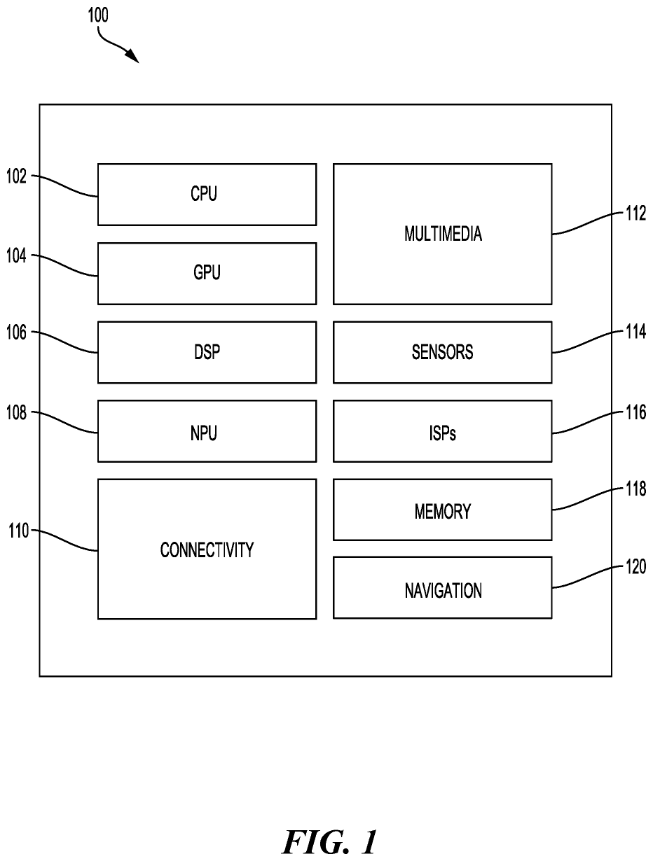

FIG. 1 illustrates an example implementation of a system-on-a-chip (SOC) 100, which may include a central processing unit (CPU) 102 or a multi-core CPU configured for adapting autoregressive inference of LLMs for static compilation. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In aspects of the present disclosure, the instructions loaded into the general-purpose processor 102 may include code to define a maximally sized static data structure and a variable data mask. The variable data mask indicates a valid section of the maximally sized data structure. The general-purpose processor 102 may also include code to determine a set of valid data by applying the variable data mask to the maximally sized static data structure. The general-purpose processor 102 may further include code to perform a computation using only the set of valid data.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

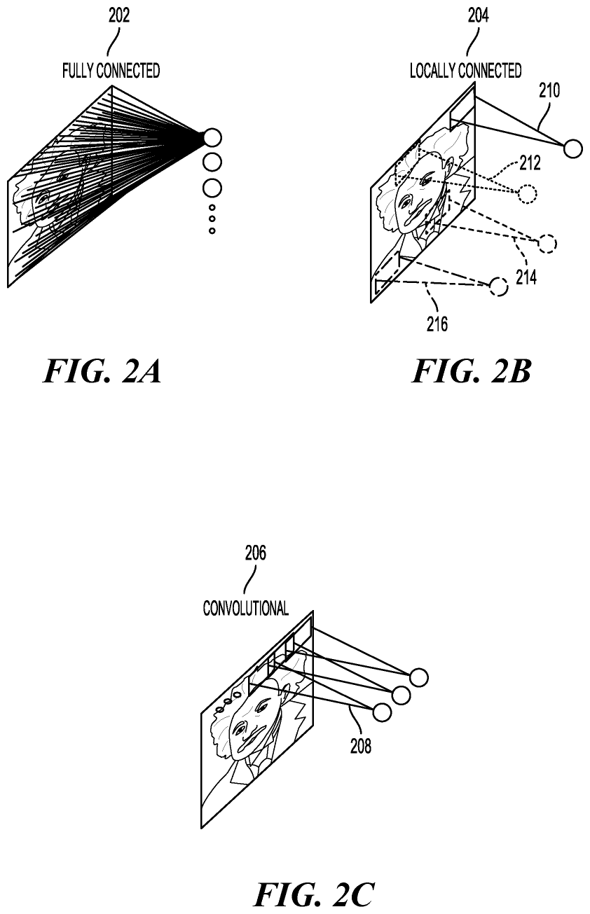

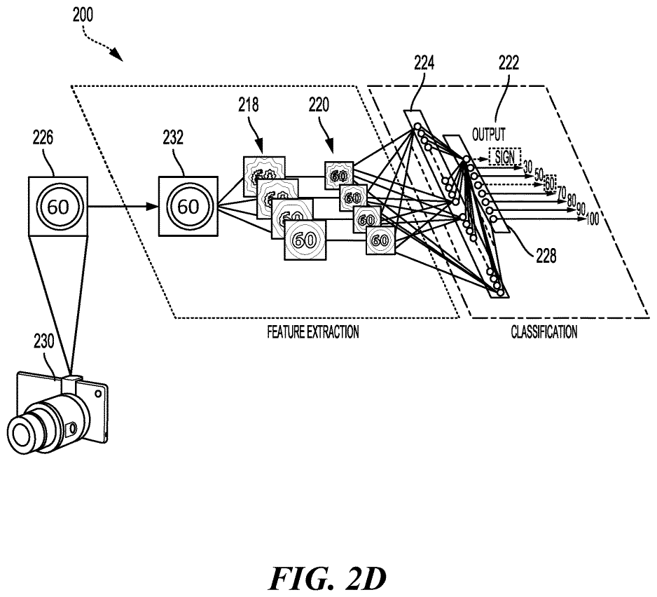

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

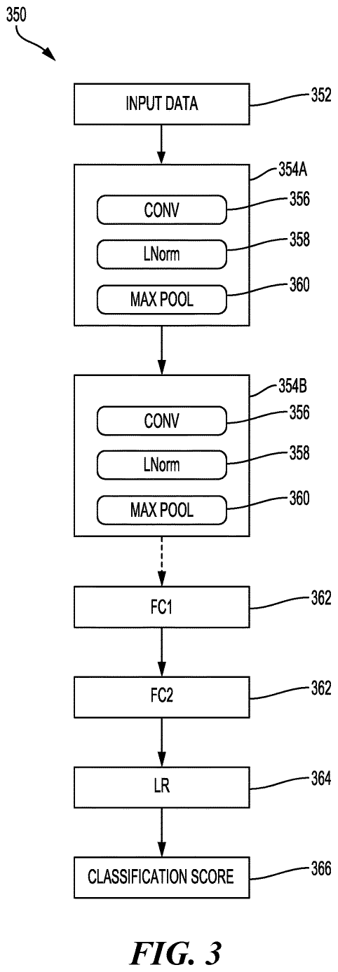

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a DCN may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

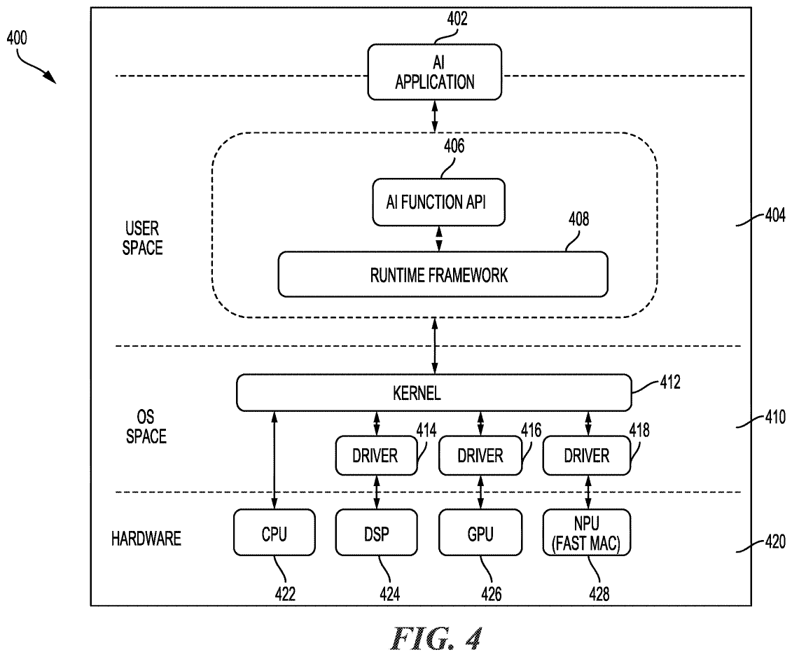

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) to support adapting autoregressive inference of large language models (LLMs) for static compilation for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

Aspects of the present disclosure are directed to adapting autoregressive inference of large language models (LLMs) for static compilation.

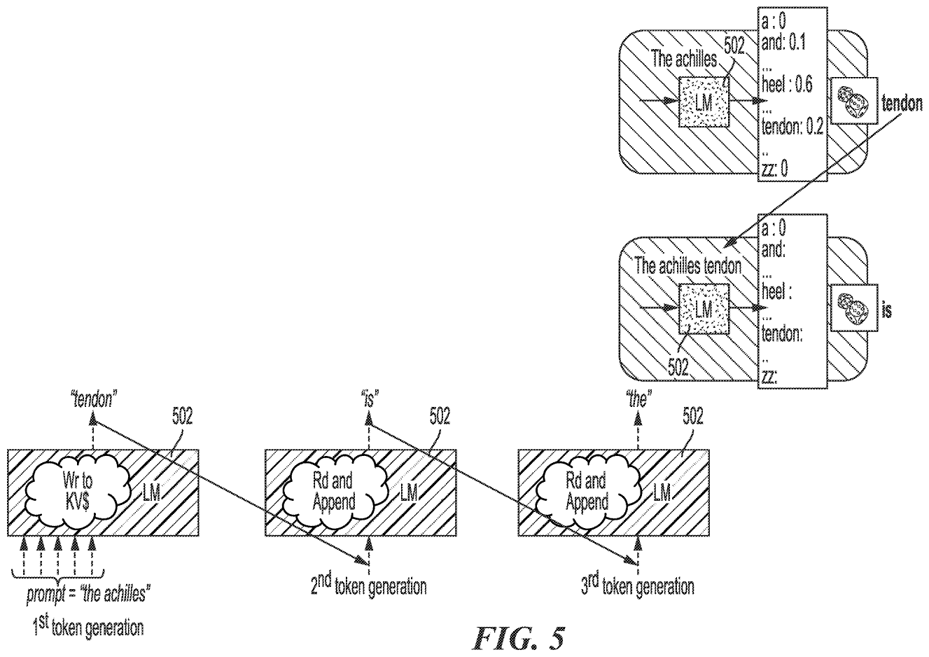

FIG. 5 is a block diagram illustrating an example of autoregressive token generation using a language model in accordance with various aspects of the present disclosure. Referring to FIG. 5, a language model 502 may receive as input a token or a string of tokens. A token may be considered a sequence of one or more characters (e.g., a token may be on average about four characters in length). Thus, the language model 502 may receive a sequence of character(s), including, but not limited to, a word, a sentence, a paragraph, or a document, for example. In an example, as shown in FIG. 5, the language model 502 may receive a phrase such as “The achilles” as an input. The language model 502 may process the input to generate a prediction of a single following token, such as the word “tendon.”

The language model 502 may be configured to generate multiple following tokens. That is, the language model 502 may be configured for autoregressive generation by invoking the language model 502 with different inputs. The following token may be appended to the input to form a next input. For instance, the language model 502 may receive a first input and may process the first input to generate a first output token. The output token may be written to memory to retain the internal state KV$ (e.g., the key variable-sized data structure is called KV Cache). The internal state may be read from memory and appended to the first input and supplied as input to the language model 502. The process may continue to be repeated in this manner. As such, the language model 502 may generate multiple tokens. However, the internal state KV$ grows in size as tokens are generated.

As described, however, autoregressive inference on large language models (LLMs) does not have such a static computational structure. The function of LLMs is to produce completions (e.g., responses) for prompts. The prompt and completion may have a variable length, for example. The completion may be produced one token at a time by executing the same computational graph a variable number of times with variable-sized data structures. A KV$ may grow in size during each iteration of token generation. Thus, it is challenging to use static compilation techniques for autoregressive inference of LLMs.

The problem of dynamism cannot simply be solved by statically defining the largest data structure that can occur, as the range of the possible values of dynamic variables may be exceedingly high. This is because doing so may greatly impair the model efficiency by possibly performing computation for invalid data in prohibitively large data structures.

In various aspects, a maximally sized data structure may be defined. The maximally sized data structure may have a fixed size. The size may be the largest context length that the LLM can handle. The largest context length may be the largest possible sum of prompt length and generation length for which the LLM may be invoked. By way of example, but not limitation, a largest context length may vary from two thousand to several hundred thousand tokens (or more) depending on the LLM, for instance.

In various aspects, a mask that indicates a currently valid section of the maximally sized data structure may be generated. The mask may be generated in accordance with a variable-sized internal state of an LLM. The KV$ is a high-dimensional tensor that may be viewed as a matrix. The KV$ may be maximally sized in rows equal to that of the maximum context length (CL). The valid portion of this matrix may begin with p rows, where p initially equals the prompt length used in a prefill stage. During each autoregressive invocation during the decode stage, p may be incremented by one. The integer p may be a compact representation of the mask.

A computation may perform a conditional computation on the mask and the maximally sized data structure. That is, the computation may be performed using only valid portions of the maximally sized data structure. For example, the conditional computation may specify:

$${qK}_{t} = where ( validMask , q * {K}_{t} , NegInf ) , \qquad ( 1 )$$

where q represents a 1×n query vector, Kₜ represents an n×n key, qKₜ represents a 1×n result vector, NegInf represents a 1×n vector of constants and validMask represents a mask indicating the valid portion of the maximally sized data structure. The operation q*Kₜ may be partially computed. That is, only the elements corresponding to the bits set in the validMask may be computed, and the other elements can be directly assigned with corresponding constant values from NegInf. As such, a static compiler may exploit the conditional compute to skip the unnecessary compute of other elements of the maximally sized data structure. In some aspects, the conditional compute may skip the complete data flow leading up to the skipped elements/compute. In some aspects, the conditional computation may skip all the memory accesses associated with the unnecessary computation.

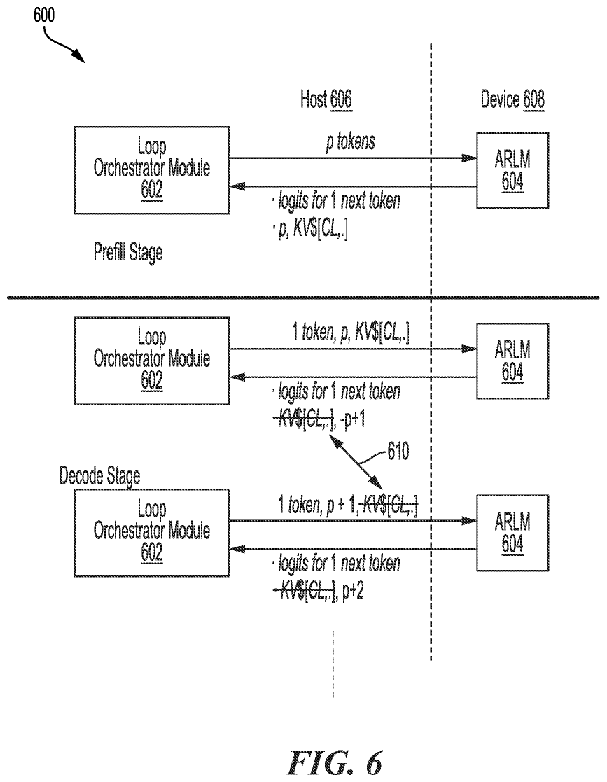

FIG. 6 is a block diagram illustrating an example architecture 600 of an autoregressive language model (ARLM) configured for static compilation, in accordance with various aspects of the present disclosure. As shown in FIG. 6, the example architecture 600 includes a loop orchestrator module 602 and an ARLM 604. The loop orchestrator module 602 may be on a host 606 and the ARLM 604 may be operated on a device 608. The host 606 may comprise, but is not limited, to an end device such as a smartphone, for example. The device 608 may comprise (but is not limited to) an inference accelerator device, for example. In some aspects, the host 606 and the device 608 may be included in the same or separate devices.

In a prefill stage (e.g., initial invocation), the loop orchestrator module 602 may provide a set of input tokens p to the ARLM 604. The set of input tokens p may be considered a prompt for the ARLM 604. The ARLM 604 processes the set of input tokens p and determines a next token. The ARLM 604 may provide the output token (or corresponding logits) to the loop orchestrator module 602 with the KV$ and the maximum context length (CL).

In a decode stage (e.g., subsequent invocations), the loop orchestrator module 602 may append the output token for the previous invocation to the set of input tokens p to form a subsequent prompt. The CL may be used to define the static data structure for the internal state KV$. Then, a valid data mask (e.g., validMask) may be generated to indicate a currently valid section of the data structure for the internal state KV$, as specified in Equation 1.

The subsequent prompt may be provided to the ARLM 604. The internal state KV$ may be maintained on the device 608. Then, rather than providing the internal state KV$, which increases in size with each invocation, the transfer of the internal state KV$ may be suppressed (indicated in the strikethrough text 610). In some aspects, compilation flags may be set during model compilation to associate suppressed model input with earlier output. The ARLM 604 may be configured to conditionally compute only the valid portions of the maximally sized data structure using the valid data mask. That is, with each subsequent invocation, the internal state may be updated on the device 608. In turn, the subsequent output token generated by the ARLM 604 may be provided to the loop orchestrator module 602. Then, additional invocations may be conducted without transferring the internal state KV$, to generate additional output tokens.

Another challenge presented by LLM deployment involves whether the loop orchestration (e.g., the autoregressive invocation of the LLM) is performed by the host 606 or by the device 608 (e.g., an inference accelerator device) itself. Performing the loop orchestration on the host 606 may provide flexibility with easy incorporation of a variety of beam search and random sampling techniques. That is, although beam search and random sampling techniques may involve scalar computations which may not ideal candidates for execution in accelerator devices, by performing loop orchestration on the host 606 may enable such techniques to be employed to determine the next input token or tokens based on the output logits from LLM.

However, the internal state (of this variable-sized structure, KV$) of the computation has to be made available for a next loop iteration to avoid the expensive re-computation of the internal state KV$. This may be achieved by transferring the variable-sized internal state KV$ through the host 606, back to the device 608 (e.g., an inference accelerator). Doing so may make the device-host link become a bottleneck, as the large sized KV$ has to be transferred back and forth via the link, which may leave the device idle during the transfer.

Accordingly, to avoid transferring the variable-sized internal state KV$ between host 606 and device 608, aspects of the present disclosure provide for partial tensor transfer. Partial tensor transfer may enable direct memory access (DMA)/data transfers associated with some inputs and outputs to be optionally suppressed during each invocation. For instance, during a first subsequent token generation (in the decode stage), the fixed-sized KV$ may be transferred to the device 608. Then, during subsequent invocations, the associated DMAs may be suppressed. Similarly, in some aspects, the output of KV$ from the device 608 to the host 606 may be suppressed on all invocations. In one example, the device 608 may pass the host 606 a buffer and the size of that buffer (e.g., size zero), and may only transfer the amount of data as indicated by the size. On the other hand, if the loop orchestration is performed on the device 608, the techniques described may still be applied to address the problem of variable-sized data structures and dynamism.

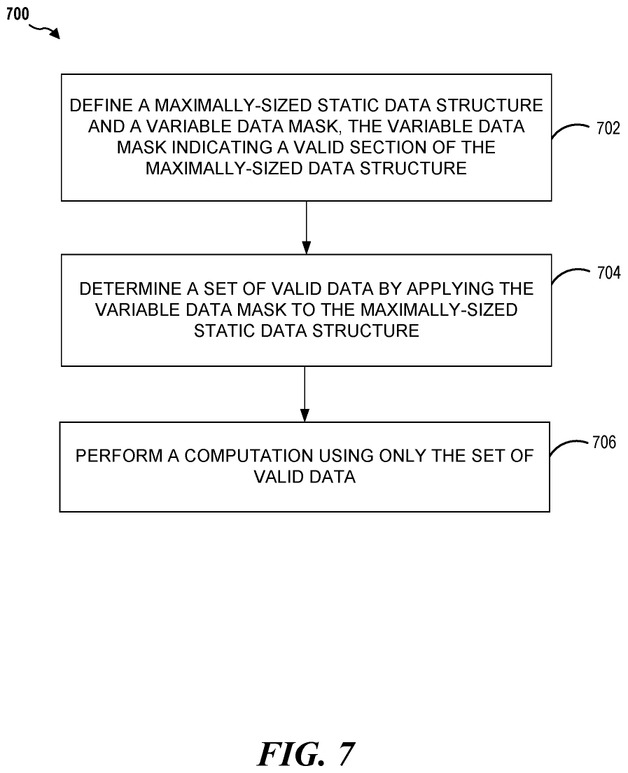

FIG. 7 is a flow diagram illustrating a processor-implemented method 700 for adapting autoregressive inference of large language models (LLMs) for static compilation, in accordance with various aspects of the present disclosure. The processor-implemented method 700 may be performed by one or more processors such as the CPU (e.g., 102, 422), GPU (e.g., 104, 426), and/or other processing unit (e.g., DSP 424, NPU 428), for example. Moreover, the processor-implemented method 700 may be implemented using a compiler.

As shown in FIG. 7, at block 702, the processor defines a maximally sized static data structure and a variable data mask. The variable data mask indicates a valid section of the maximally sized static data structure. As described, for instance with reference to FIG. 6, the maximal context length (CL) may be used to define the static data structure for the internal state KV$. Then, a valid data mask (e.g., validMask) may be generated to indicate a currently valid section of the data structure for the internal state KV$. In some aspects, the variable data mask may be generated in accordance with tokens generated by an autoregressive LLM, for example.

At block 704, the processor determines a set of valid data by applying the variable data mask to the maximally sized static data structure. The set of valid data has a variable size. For example, as described with reference to FIG. 6, a currently valid section of the data structure for the internal state KV$ by applying the valid data mask to the maximally sized data structure, as specified in Equation 1. In some aspects, the set of valid data may be generated by an LLM. For example, the set of valid data may comprise the internal state KV$ associated with the LLM.

At block 706, the processor performs a computation using only the set of valid data. As described, for example, with reference to FIG. 6, the ARLM 604 may be configured to conditionally compute only the valid portions of the maximally sized data structure using the valid data mask. For instance, the computation using only the set of valid data may be used to generate an inference related to a prompt of the large language model. In various aspects, code (e.g., executable code) to perform the computation using the set of valid data may be generated in advance of runtime. For instance, the code may be generated during model compilation time. In some aspects, the code may specified to perform minimal computations using the set of valid data. That is, the code may be defined to reduce, and in some cases, avoid over computation (e.g., performing additional computations to produce the same or similar functionally correct result) using the conditional compute technique described.

Implementation examples are included in the following numbered clauses.
1. An apparatus comprising:
   at least one memory; and
   at least one processor coupled to the at least one memory, the at least one processor configured to:
      define a maximally sized static data structure and a variable data mask, the variable data mask indicating a valid section of the maximally sized static data structure;
      determine a set of valid data by applying the variable data mask to the maximally sized static data structure; and
      perform a computation using only the set of valid data.
2. The apparatus of clause 1, in which the set of valid data has a variable size.
3. The apparatus of clause 1 or 2, in which the set of valid data is generated by a large language model.
4. The apparatus of any of clauses 1-3, in which the set of valid data comprises an internal state associated with the large language model.
5. The apparatus of any of clauses 1-4, in which the internal state is retained on an inference accelerator device.
6. The apparatus of any of clauses 1-5, in which the at least one processor is further configured to suppress transferring at least one of an input or an output during a subsequent invocation of the large language model.
7. The apparatus of any of clauses 1-6, in which a compiler associates the internal state with a suppressed input.
8. The apparatus of any of clauses 1-7, in which the large language model is implemented on an inference accelerator.
9. The apparatus of any of clauses 1-8, in which the at least one processor is further configured to generate, in advance of runtime, code to perform minimal computations using the set of valid data.
10. A processor-implemented method performed by at least one processor, the processor-implemented method comprising:
   defining a maximally sized static data structure and a variable data mask, the variable data mask indicating a valid section of the maximally sized static data structure;
   determining a set of valid data by applying the variable data mask to the maximally sized static data structure; and
   performing a computation using only the set of valid data.
11. The processor-implemented method of clause 10, in which the set of valid data has a variable size.
12. The processor-implemented method of clause 10 or 11, in which the set of valid data is generated by a large language model.
13. The processor-implemented method of any of clauses 10-12, in which the set of valid data comprises an internal state associated with the large language model.
14. The processor-implemented method of any of clauses 10-13, in which the internal state is retained on an inference accelerator device.
15. The processor-implemented method of any of clauses 10-14, further comprising suppressing transfer of at least one of an input or an output during a subsequent invocation of the large language model.
16. The processor-implemented method of any of clauses 10-15, in which a compiler associates the internal state with a suppressed input.
17. The processor-implemented method of any of clauses 10-16, in which the large language model is implemented on an inference accelerator.
18. The processor-implemented method of any of clauses 10-17, further comprising generating, in advance of runtime, code to perform minimal computations using the set of valid data.
19. A non-transitory computer-readable medium having program code recorded thereon, the program code executed by a processor and comprising:
   program code to define a maximally sized static data structure and a variable data mask, the variable data mask indicating a valid section of the maximally sized static data structure;
   program code to determine a set of valid data by applying the variable data mask to the maximally sized static data structure; and
   program code to perform a computation using only the set of valid data.
20. An apparatus comprising:
   means for defining a maximally sized static data structure and a variable data mask, the variable data mask indicating a valid section of the maximally sized static data structure;
   means for determining a set of valid data by applying the variable data mask to the maximally sized static data structure; and
   means for performing a computation using only the set of valid data.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described, in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus comprising:
at least one memory; and
at least one processor coupled to the at least one memory, the at least one processor configured to:
define a maximally sized static data structure and a variable data mask, the variable data mask indicating a valid section of the maximally sized static data structure;
determine a set of valid data by applying the variable data mask to the maximally sized static data structure; and
perform a computation using only the set of valid data.

2. The apparatus of claim 1, in which the set of valid data has a variable size.

3. The apparatus of claim 1, in which the set of valid data is generated by a large language model.

4. The apparatus of claim 3, in which the set of valid data comprises an internal state associated with the large language model.

5. The apparatus of claim 4, in which the internal state is retained on an inference accelerator device.

6. The apparatus of claim 5, in which the at least one processor is further configured to suppress transferring at least one of an input or an output during a subsequent invocation of the large language model.

7. The apparatus of claim 6, in which a compiler associates the internal state with a suppressed input.

8. The apparatus of claim 3, in which the large language model is implemented on an inference accelerator.

9. The apparatus of claim 1, in which the at least one processor is further configured to generate, in advance of runtime, code to perform minimal computations using the set of valid data.

10. A processor-implemented method performed by at least one processor, the processor-implemented method comprising:
defining a maximally sized static data structure and a variable data mask, the variable data mask indicating a valid section of the maximally sized static data structure;
determining a set of valid data by applying the variable data mask to the maximally sized static data structure; and
performing a computation using only the set of valid data.

11. The processor-implemented method of claim 10, in which the set of valid data has a variable size.

12. The processor-implemented method of claim 10, in which the set of valid data is generated by a large language model.

13. The processor-implemented method of claim 12, in which the set of valid data comprises an internal state associated with the large language model.

14. The processor-implemented method of claim 13, in which the internal state is retained on an inference accelerator device.

15. The processor-implemented method of claim 14, further comprising suppressing transfer of at least one of an input or an output during a subsequent invocation of the large language model.

16. The processor-implemented method of claim 15, in which a compiler associates the internal state with a suppressed input.

17. The processor-implemented method of claim 12, in which the large language model is implemented on an inference accelerator.

18. The processor-implemented method of claim 10, further comprising generating, in advance of runtime, code to perform minimal computations using the set of valid data.

19. An apparatus comprising:
means for defining a maximally sized static data structure and a variable data mask, the variable data mask indicating a valid section of the maximally sized static data structure;
means for determining a set of valid data by applying the variable data mask to the maximally sized static data structure; and
means for performing a computation using only the set of valid data.
